(19) United States
(12) Patent Application Publication
(10) Pub. No.: US 2009/0327058 A1
(43) Pub. Date: Dec. 31, 2009

(54) METHOD FOR OBTAINING STATISTICAL SYSTEMS OF PROFILES OF SUITABILITY FOR THE ADVERTISING OF PRODUCTS OR SERVICES

(76) Inventors: Alberto GIL CLEMENTE, Valencia (ES); Carlos Garcia Aparicio, Valencia (ES)

Correspondence Address: WENDEROTH, LIND & PONACK, L.L.P., 1030 15th Street, N.W.,, Suite 400 East, Washington, DC, 20005-1503, US

(21) Appl. No.: 12/493,421

(22) Filed: Jun. 29, 2009

(30) Foreign Application Priority Data
Jun. 30, 2008 (ES) P200801959

(51) Int. Cl. G06Q 30/00

(52) U.S. Cl. 705/14.2; 705/14.44

(57) ABSTRACT

Mainly on the Internet (though extendible to any other communications or advertising medium, present or future), which offers great advantages both to those at whom a product or service is offered, as consumers, and to suppliers of services or contents.

It consists of the displaying of normally multimedia presentations of a product or service by means of an advertising message and which will habitually include a brief questionnaire on what is shown in the message, on the consumer him or herself, or any other data which the advertiser considers to be relevant and useful.

When looking at the message and replying to its questionnaire (if there is one), the possible consumer will obtain a certain number of credits that will be able to be used as if they were virtual money in various payment services.

### OBJECT OF THE INVENTION

The present invention relates to a method for obtaining statistical systems of profiles of suitability for the advertising of products or services with the aim of gathering data on a possible client, mainly on the Internet (though extendible to any other communications or advertising medium, present or future), which offers great advantages both to those at whom a product or service is offered, as consumers, and to suppliers of services or contents.

It consists of the displaying of normally multimedia presentations of a product or service by means of an advertising message and which will habitually include a brief questionnaire on what is shown in the message, on the consumer him or herself, or any other data which the advertiser or popularizer considers to be relevant and useful.

When looking at the message and replying to its questionnaire (if there is one), the possible consumer will obtain a certain number of credits that will be able to be used as if they were virtual money in various payment services provided by the suppliers of services or contents, attached to the system, whether these services or contents accord with the nature of the Internet or not, along with their exchange for other types of services that are considered appropriate (among others: online games, other Internet payment services, downloading of contents to telephones or mobile devices, participation in contests and promotions, or similar).

### BACKGROUND OF THE INVENTION

There exist many different means for the advertising of messages on the Internet, though in their current form they all suffer from certain unavoidable defects.

To cite some of these means and their problems:
Banners: small graphic images or animations (similar to the logos of websites) which link to the advertiser's site when clicked on. This is based on payment of a certain sum of money to the owner of the website hosting the “banner” each time that “banner” is clicked on.

Some of its drawbacks are: its vulnerability to “bots” programs (automatic programs that perform some kind of function) designed for automatically clicking on the “banners” and thereby artificially and fraudulently increasing the number of clicks and therefore the money which the advertiser pays to the owner of site.

Another drawback is the amount of extra information which the website has to load for each “banner” it includes, since this is information that has to be downloaded by the data connection of each user accessing the website, which can cause it to take a long time to load the page and which is ignored by the public.

Moreover, animated “banners” can be annoying and make it difficult for anyone consulting the page to look at the contents, and they sometimes include annoying sound or optical effects.
Sponsored searches: these are results offered by search sites in the form of links, along with the other links resulting from the actual search, and which are related to the key words or concepts on which the search is conducted.

Drawbacks: mainly the fact that the user can find it difficult to differentiate between these sponsored results and those due to the search, and they can confuse and even annoy the user attempting to find certain information and can end in the page not showing the user what he or she is expecting to find.

In fact, consumer associations have even denounced search sites for this reason.

Pop-up windows: windows or pages that appear when the user accesses a site.

There are various types of these, though in general they consists of a box or window, which opens without the consent of the user and which is superimposed on the page it is wished to see, preventing him or her from being able to see the page until the pop-up window closes.

Drawbacks: they are so annoying for users that tools have appeared to block these pop-up windows.

Also, in websites where these are used to an abusive degree, there can be so many opening simultaneously that the user's computer can become blocked due all the resources of the process or the RAM memory being used.

All these methods also suffer from various disadvantages that common to some or all of them:
They are indiscriminate: there is no way of knowing the consumer profile at which the message is being targeted beyond the highly limited method of choosing the page in which it is inserted according to statistics on the class of users who visit each page, or by relating the message to some term written by the user in a search.

No kind of security can be had regarding sex, age, educational level, professional field, hobbies or similar, all of which is data of great utility when it comes to focusing the advertising on a defined target public.
They are inefficient and uncertain: users do not usually devote themselves to searching for advertisements on the Internet oust as they do not watch television for the adverts), so the ones that appear are usually ignored. And even if they are not ignored there is no way of knowing whether this advertisement has had any kind of impact or the consumer has liked it.
They disturb and annoy consumers: they are very often distracting, they make it difficult to use the Internet and to consult websites, or they slow down the work and the user's computer due to acting indiscriminately. This merely annoys the consumer and makes him or her negatively predisposed towards the advertisement.

### STATE OF THE ART

The applicants are not so far aware of any system or method similar to that being applied for.

### DESCRIPTION OF THE INVENTION

In the present description, the term “system” refers on an overall basis to the entire company managing the advertising model; the term “advertiser” refers to the company or individual wishing to use the services of the system, for offering their messages to consumers; the term “consumer” refers to the person at whom the messages are sought to be targeted and who, on account of the nature of the advertising model, probably corresponds to a typical Internet user; the term “supplier” refers to the company or individual offering some kind of service or content, which is suitable for being paid with real money or with virtual money obtained by the consumers in the system.

In the advertising model, some brief messages offered by the advertisers to the consumers will be voluntarily looked at by the latter, and in exchange those consumers will obtain a certain number of credits which will be able to be used as if it were virtual money in any payment service or content attached to the system.

The message will consist of presentations of any kind which the consumers can watch or look at, and on which a questionnaire will be able to be put to him or her with questions on what is displayed in the presentation or any other kind of question if so wished.

The consumer will obtain credits for looking at that advertisement, though answering the questionnaire correctly could be a requisite for obtaining those credits.

The credits which the consumer wins and accumulates will be used as if they were money in any supplier of services or contents or of any other activity suitable for being paid with the credits obtained, and who have previously decided to work with the system.

Each advertiser of the system will be invoiced a certain sum of money for each credit which the consumers have obtained by looking at their advertisements.

The suppliers will be paid a certain sum for each credit which the consumers pay in their services or contents.

The profit from the system is obtained, among other means, from the difference between what the system collects from the advertisers for each credit granted to the consumers, and what the system pays to the suppliers for each credit spent on them by the consumers. This is in addition to other commissions that can be established.

If there is a questionnaire, they will normally have the format of a form with test-type questions or in which the opinion is asked of the user.

Each questionnaire will have a limited number of questions so that it is not inconvenient to answer, though the advertiser can have a lot of different questions that are put randomly in each questionnaire in order to obtain a more varied sample of replies.

There are several motives for this questionnaire:
The main one, which is that if it obliges the user to answer it correctly, then he or she has to pay active attention to the content of the message in order to know the reply to the questions, which ensures us that the user will be paying attention to the message.
If the advertisers produce a good battery of questions they can obtain some statistics on the replies equivalent to expensive surveys and market studies. They can also rapidly and almost immediately see the impact achieved by their message and be able to adapt it better and faster to their target public.
If the consumers state their generic profile (for example: age, sex, nationality, level of studies, etc.) the advertisers can obtain even more clarifying results on their consumers, and also, if they filter the consumers according to the characteristics of their profile they can produce specific messages for different groups and achieve a greater impact than with generic messages.

When they register, consumers can be asked to fill in a form with their data, preferably generic and fairly non-sensitive (for example: sex, age, level of studies, professional field, country and city of origin and/or residence).

If this is done, by having generic data on the consumers we can make a selection of them according to a particular profile, so that they can be most suited to a specific message.

The advertisers can also decide that certain products are of no interest to certain sectors and cannot be visited by that sector, in order to save money on useless messages (for example, car accessories for consumers who are too young to hold a driving license).

With this a method of advertising is achieved that can discriminate the type of consumer who can see each message and focus them easily on certain market niches.

### ADVANTAGES

The advantages of this invention are revealed from the descriptive specification, though below we cite the most outstanding advantages by way of illustration only without being limiting:
Since it is not an intrusive model of advertising, and it also offers users something in exchange for their attention and time, the negative feeling of the possible consumer is successfully eliminated, since the messages appear at the will of the client and are useful and friendly, given that, in exchange for a small fraction of the user's time and attention, they are offered services that are useful or entertaining for which they would otherwise have to pay.
Since the user does not have to use real money in his or her transactions in the system, they do not need to provide sensitive data of a personal or economic nature that arouse suspicions that are typical in electronic commerce. No money is handled, therefore there is no need to ask the user for details of bank accounts or credit cards. No are any periodical quotas required for enjoying the services. Moreover, as no real money is handled, it attracts the consumer who does not use payment services or contents due to being unable or unwilling to pay for them, or who does not wish to subscribe to a service that he or she cannot try without first paying for.

This encourages a lot of consumers who have never used payment services to use them, converting each consumer into a potential client.

This is an enormous advantage for the suppliers, who will see their potential client base increase hugely, since consumers only have to access the supplier's service and pay with credits for the services they use, without any greater risk or complication.

### DRAWINGS

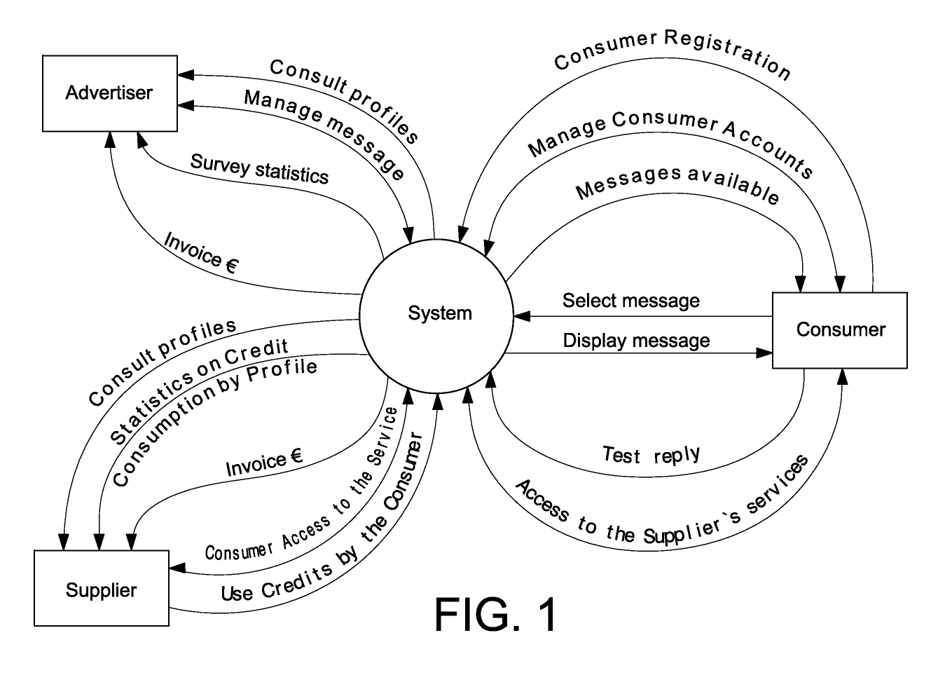

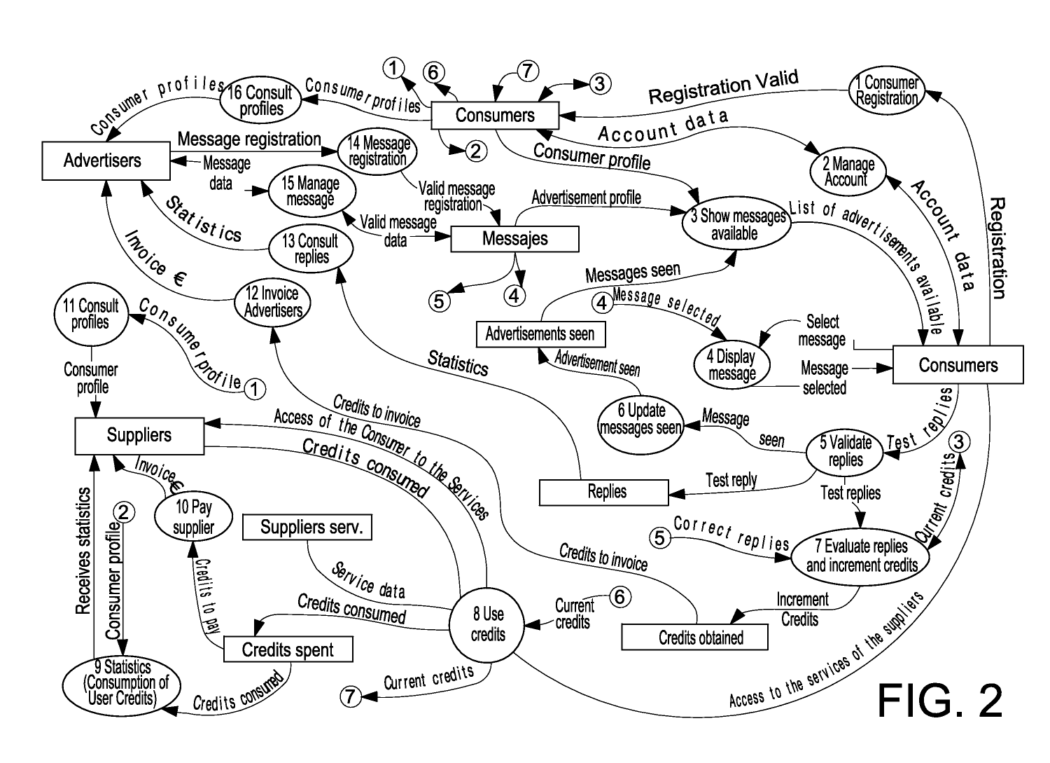

For a better understanding of this specification, attached at the end hereof are some diagrams (FIGS. 1 and 2) intended to display the systems by means of their explanatory layouts:
The closed boxes are External Entities, in other words “real players” in all this, private individuals or corporate bodies.
The open rectangles are “Data Stores”, we could say that they are databases though the meaning is broader since Data Stores encompass databases and other types of storage.
The Balloons are “processes”, in other words, actions of the systems initiated or triggered by the external entities. They are Real Actions.
The Arrows represent “Information Streams” which is the information that moves and is used among the different elements of the system and which is also sent to or received from the external entities.

### DESCRIPTION OF A DETAILED MODE OF EMBODIMENT

First the system (company that manages the advertising service, payments, credits, etc.) is created.

Advertisers are sought who wish to introduce messages related to their products or services.

The advertisers provide messages with their corresponding questionnaires to the system so that they can be made accessible by the consumers. If the advertiser wishes he can also establish filters on the consumers who can access his messages, based on the data of the consumer profile. The advertisers can establish the duration of a campaign, the maximum amount that they wish to pay altogether on account of a particular message being seen or similar.

These messages will be a multimedia presentation of short duration in order not to tire or bore the consumer, of the sequence or images type or an animation, which will be able to be accompanied with an audio of the television spot type. The message will also be accompanied by a questionnaire.

This questionnaire will have to be answered with a certain degree of truthfulness or relevance so that the user can receive the credits determined and notified to the users in advance.

The questionnaires will be of the test-type battery of multiple-response questions.

Although the number of questions and answers per question will be limited in each questionnaire, in order not to be tiring or annoying to the user, the advertiser will be able to make a list with as many questions and answers for each question as he wishes, and the system will randomly generate a different questionnaire for each consumer accessing the message.

Among others, the advertiser would have to ask about the content of the message in itself, in order to make sure that the consumer sees it (these are the questions that have to be answered correctly) and that his message is understood by the consumers it is targeted at. He will also be able to ask their opinion on the message (without the replies counting as being right or wrong in the test).

The replies to these questions also allow the advertiser to obtain almost immediate replies from his possible clients, and is in itself a useful survey and market study without any additional cost for the advertiser. Obviously, the data on the replies to each message will be accessible as statistics only to the advertisers to whom the messages belong.

Suppliers of services or contents are sought who wish to use the credits system as a unique or alternative form of payment to other forms of payment that are available.

Consumers are allowed to register in the system's database. First they will be asked to state the user name and the password that they wish (the usual process in any registration in an Internet service), along with their language.

In the registration process, and in order to be able to have profiles of the consumers, they are asked for the following data among others: sex, year of birth, civil status, country and city of residence, field of studies and level reached, hobbies and similar.

They will never be asked personal details such as their full name, physical address, bank details and similar, since such details are not necessary for conducting an advertising campaign and they could discourage the user from using the system.

Nor are questions asked of a sensitive nature, such as religion, sexual orientation, ethnic group or similar.

In order to avoid a profusion of subjective data in the system's database, the replies will be predefined in dropdown lists or similar, for example the date of birth will be selected from a list showing the years, the countries and cities from a list of a list, the civil status will be selected from among those shown. The uniformity of the replies makes them easy to filter afterwards in searches made in terms of consumer profiles on the system's databases.

The consumers ask the system (via the system's website) for a list of messages that are available for seeing (there must always be enough so that, when seeing them, the consumer can obtain the necessary credits for being able to use the services of the suppliers without any problems).

The system consults the message database, and shows a list with all the messages available for the profile of the consumer.

The consumer sees the message, replies to the test and, if he replies correctly, obtains credits.

The system will invoice the advertisers for the corresponding quantity according to the credits which the consumers obtain in each of them.

The consumer will be able to access (via the system's website) the list of services or contents offered by the suppliers. And he will be able to access them and pay for the services with the credits that are available at that moment. If he does not have credits, then he simply has to see more messages in order to obtain new credits.

The supplier will allow consumers having credits (the system will take charge of stating whether a particular consumer wishing to access the service has credits available or not) to spend them on his services as if they were money.

The credits that are spent on the supplier's services will be invoiced to the system, which will pay him the corresponding sum.

By way of example, the following summary is given:

Some messages are created with their corresponding tests, and they are placed in the system at the disposal of the users.

The users see the messages and reply to the tests, with those users who respond correctly obtaining credits.

The users then access the payment services that work with the system, and use their online games or their downloads of contents, paying for them with the credits.

The advertiser pays the system the credits for the messages seen, and the system pays the suppliers for the services that have been provided in exchange for the credits.

### Details of the Processes

### 1) Consumer Registration

The consumer fills in the registration form, his or her data is validated and a new register is created in the “Consumers” data store.

### 2) Managing the Account

The consumer accesses the data of his or her account/profile.

He or she modifies them if wished, and if so they are validated and the register is updated in the “Consumers” data store.

### 3) Show Available Messages

A search is made for messages available to the consumer, for which the consumer profile is consulted and those messages available for him are filtered; from this selection those messages that have already been seen are eliminated.

The consumer is shown the list of available messages.

(The messages are consulted from the “messages” data store and the messages seen from the “messages seen” data store.)

### 4) Display Message

The consumer chooses a message from the list obtained in the previous step.

The message is retrieved from the “messages” store and is displayed to the consumer.

### 5) Validate Replies

The consumer replies to the test included in the message.

The replies are validated.

The new register is added to the “Replies” store.

Information is sent to processes 6 and 7.

### 6) Update Messages Seen.

With the data coming from process 5, the new register is added to the “messages seen” store.

### 7) Evaluate Replies and Increment Credits.

With the data coming from process 5, the replies from the consumer are compared to the correct replies for the message.

If the test has been replied to correctly according to certain given criteria, the credits gained are added to the “credits obtained” store (for example, though without limiting ourselves to this: achieving a certain level of correct answers, correctly replying to certain questions in particular, or simply filling in an opinion survey) and the present credits in the consumer's account are updated.

### 8) Using Credits

This permits access by consumers to the services and/or contents of the suppliers, for which it attends to requests for consumption of credits made by the suppliers.

It consults the consumer's credits that are available and the characteristics of the service, and it informs the supplier of whether they are sufficient for paying for the use of its services and/or contents. If so, it calculates the credits remaining in the account of the consumer and updates them, and the transaction is recorded in the “credits spent” store.

### 9) Statistics (Consumption of User Credits)

The supplier requests statistical data on the manner of use and type of consumer using its services and/or contents. For this, we obtain crossed data from the stores “credits spent” and “consumers”.

### 10) Paying the Supplier

The number of credits the consumers have spent on the supplier's services in a certain interval of time is calculated and a pro-forma invoice is issued.

### 11) Consulting Profiles

The supplier statistically consults the profiles of the consumers to see how they are adapted to its services.

### 12) Invoicing the Advertiser

The number of credits obtained by the consumers of the advertiser via the system is calculated and the invoice is issued.

### 13) Consulting Replies

The advertiser statistically consults the replies given to his messages or surveys by the consumers, thereby obtaining statistics equivalent to surveys and market studies.

### 14) Registration of Message

The advertiser introduces the data for a new message.

The introduced data is validated.

It is added to the “messages” store.

### 15) Managing Messages

The advertiser accesses the data and options for his messages.

If they are modified, the “messages” store is updated.

### 16) Consulting Profiles

The advertiser statistically consults the profiles of the consumers in order to adapt his message to his target public.

The system can also be worked by means of mobile telephone or other similar medium.

### Data Dictionary

Not all the necessary fields are specified nor does this aim to be an exhaustive description, rather, it serves as part of the previous example and for improving its comprehension.

Moreover, and in order to facilitate its understanding, below many of the descriptions of stores and streams is an explanation of their function or significance, preceded by a *.

The data is shown with its name within the store to which it belongs, or as “name_store.Name_field” if it is obtained from another data store.

For example: in the store “Replies” the field “Messages.ID” signifies that the field “ID” is obtained from the store “Messages”.

The data can appear between “( )” or “[ ]”.

Between round brackets indicates an obligatory data group, and between square bracket indicates that it is optional.

For example: in the store “Messages” appears “[(questions, correct_replies)]”, which indicates that it is optional for there to be a questionnaire but if there is one, then it must necessarily include the questions and possible replies.

### Data Stores

Messages: name, ID, (message [animation, graphics, sound, text, etc]), [(questions, correct_replies)], consumer_profile, description
The message in itself, as with the information and characteristics of it, and if there is one, the questionnaire with its replies.

### Messages Seen: Messages.ID, Consumers.ID

The identifier of the message along with that of the consumer who has seen it.
   Consumers: user, password, ID, (other personal data that might be necessary), present_credits
The user and password chosen by the consumer, along with his or her personal data and the credits he or she has at present.
   Credits Spent: Consumers.ID, Serv_Suppliers.ID, credits_spent
It identifies how many credits a user has spent on a particular service.
   Credits Obtained Messages.ID, Consumers.ID, credits_obtained
It identifies how many credits a user has obtained looking at a particular message.
   Replies: Messages.ID, Consumers.ID, (replies to the test)
It saves the replies from a consumer to a particular message.
   Serv Suppliers: ID, credits_price
It indicates the cost in credits of a particular service.

### Data Streams

Consumer registration: new_user, new_password, (other personal data that might be necessary)
Data of a new consumer it is wished to create.
   Message registration: name, (message [animation, graphics, sound, text, etc]), [questions, correct_replies], consumer_profile, description
Data of the new message it is wished to add to the system.
   Selected message: Messages.ID, (message [animation, graphics, sound, text, etc]), [questions]
Data of the particular message selected by the consumer.
   Message seen: Messages.ID, Consumers.ID
It identifies a message and the consumer who has seen it.
   Messages seen: Messages.ID, Consumers.ID
It identifies a message and the consumer who has seen it.
   Present credits: ID, present_credits
The credits which the consumer has at that moment.
   Credits to pay: Consumers.ID, Serv_Suppliers.ID, credits_spent
All the expenses of each consumer on each service, in order to be able to generate an invoice.
   Credits to invoice: Messages.ID, credits
All the credits obtained by looking at messages, in order to be able to generate an invoice.
   Credits consumed: Consumers.ID, Serv_Suppliers.ID, credits_spent
The credits spent by the consumer on the service.
   Message data: name, ID, (message [animation, graphics, sound, text, etc]), [questions, correct_replies], consumer_profile, description.
   Account data: user, password, (other personal data that might be necessary)
   Service data: ID, credits_price.
   Credits increment: Messages. ID, Consumers.ID, credits_obtained.
   List of available messages: Messages.ID, Messages.description.
   Message profile: ID, consumer_profile.
It defines the consumer profile at whom the message is aimed.
   Consumer profile: ID, (personal data)
The consumer profile, used for determining whether it is compatible with the profile of a given message.
   Consumer profiles: Consumers.(personal data)
The consumer profile data, in order to be able to produce statistics on the types of consumer existing in the system.
   Test replies: Messages.ID, Consumers.ID, replies_from_consumer_to_test
   Correct replies: ID, correct_replies
   Select message: Messages.ID
   Selected message: Messages.ID, (message [animation, graphics, sound, text, etc]), [questions]
Data of the particular message selected by the consumer.
   Message seen: Messages.ID, Consumers.ID
It identifies a message and the consumer who has seen it.
   Messages seen: Messages.ID, Consumers.ID
It identifies a message and the consumer who has seen it.
   Present credits: ID, present_credits
The credits which the consumer has at that moment.
   Credits to pay: Consumers.ID, Serv_Suppliers.ID, credits_spent
All the expenses of each consumer on each service, in order to be able to generate an invoice.
   Credits to invoice: Messages.ID, credits
All the credits obtained by looking at messages, in order to be able to generate an invoice.
   Credits consumed: Consumers.ID, Serv_Suppliers.ID, credits_spent
The credits spent by the consumer on the service.
   Message data: name, ID, (message [animation, graphics, sound, text, etc]), [questions, correct_replies], consumer_profile, description
   Account data: user, password, (other personal data that might be necessary)
   Service data: ID, credits_price
   Credits increment: Messages.ID, Consumers.ID, credits_obtained
   List of available messages: Messages.ID, Messages.description
   Message profile: ID, consumer_profile
It defines the consumer profile at whom the message is aimed.
   Consumer profile: ID, (personal data)
The consumer profile, used for determining whether it is compatible with the profile of a given message.
   Consumer profiles: Consumers.(personal data)
The consumer profile data, in order to be able to produce statistics on the types of consumer existing in the system.
   Test replies: Messages.ID, Consumers.ID, replies_from_consumer_to_test
   Correct replies: ID, correct replies
   Select message: Messages.ID

1. Method for obtaining statistical systems of profiles of suitability for the advertising of products or services characterized in that first the system (company that manages the advertising service, payments, credits, etc.) is created.
Advertisers are sought who wish to introduce messages related to their products or services.
The advertisers provide messages with their corresponding questionnaires to the system so that they can be made accessible by the consumers. If the advertiser wishes he can also establish filters on the consumers who can access his messages, based on the data of the consumer profile.
The advertisers can establish the duration of a campaign, the maximum amount that they wish to pay altogether on account of a particular message being seen or similar.
These messages will be a multimedia presentation of short duration in order not to tire or bore the consumer, of the sequence or images type or an animation, which will be able to be accompanied with an audio of the television spot type.
The message will also be accompanied by a questionnaire.
This questionnaire will have to be answered with a certain degree of truthfulness or relevance so that the user can receive the credits determined and notified to the users in advance.
The questionnaires will be of the test-type battery of multiple-response questions.
Although the number of questions and answers per question will be limited in each questionnaire, in order not to be tiring or annoying to the user, the advertiser will be able to make a list with as many questions and answers for each question as he wishes, and the system will randomly generate a different questionnaire for each consumer accessing the message.
Among others, the advertiser would have to ask about the content of the message in itself, in order to make sure that the consumer sees it (these are the questions that have to be answered correctly) and that his message is understood by the consumers it is targeted at. He will also be able to ask their opinion on the message (without the replies counting as being right or wrong in the test).
The replies to these questions also allow the advertiser to obtain almost immediate replies from his possible clients, and is in itself a useful survey and market study without any additional cost for the advertiser. Obviously, the data on the replies to each message will be accessible as statistics only to the advertisers to whom the messages belong.
Suppliers of services or contents are sought who wish to use the credits system as a unique and alternative form of payment to other forms of payment that are available.
Consumers are allowed to register in the system's database.
First they will be asked to state the user name and the password that they wish (the usual process in any registration in an Internet service), along with their language.
In the registration process, and in order to be able to have profiles of the consumers, they are asked for the following data among others: sex, year of birth, civil status, country and city of residence, field of studies and level reached, hobbies and similar.
They will never be asked personal details such as their full name, physical address, bank details and similar, since such details are not necessary for conducting an advertising campaign and they could discourage the user from using the system.
Nor are questions asked of a sensitive nature, such as religion, sexual orientation, ethnic group or similar.
In order to avoid a profusion of subjective data in the system's database, the replies will be predefined in dropdown lists or similar, for example the date of birth will be selected from a list showing the years, the countries and cities from a list of a list, the civil status will be selected from among those shown. The uniformity of the replies makes them easy to filter afterwards in searches made in terms of consumer profiles on the system's databases.
The consumers ask the system (via the system's website) for a list of messages that are available for seeing (there must always be enough so that, when seeing them, the consumer can obtain the necessary credits for being able to use the services of the suppliers without any problems).
The system consults the message database, and shows a list with all the messages available for the profile of the consumer.
The consumer sees the message, replies to the test and, if he replies correctly, obtains credits.
The system will invoice the advertisers for the corresponding quantity according to the credits which the consumers obtain in each of them.
The consumer will be able to access (via the system's website) the list of services or contents offered by the suppliers. And he will be able to access them and pay for the services with the credits that are available at that moment. If he does not have credits, he simply has to see more messages in order to obtain new credits.
The supplier will allow consumers having credits (the system will take charge of stating whether a particular consumer wishing to access the service has credits available or not) to spend them on his services as if they were money.
The credits that are spent on the supplier's services will be invoiced to the system, which will pay him the corresponding sum.

2. Method for obtaining statistical systems of profiles of suitability for the advertising of products or services, in accordance with claim one, characterized in that the consumer fills in the registration form, his or her data is validated and a new register is created in the “Consumers” data store.
2) Managing the account
The consumer accesses the data of his or her account/profile.
He or she modifies them if wished, and if so they are validated and the register is updated in the “Consumers” data store.
3) Show available messages
A search is made for messages available to the consumer, for which the consumer profile is consulted and those messages available for him are filtered; from this selection those messages that have already been seen are eliminated.
The consumer is shown the list of available messages.
(The messages are consulted from the “messages” data store and the messages seen from the “messages seen” data store.)
4) Display message
The consumer chooses a message from the list obtained in the previous step.
The message is retrieved from the “messages” store and is displayed to the consumer.
5) Validate replies
The consumer replies to the test included in the message.
The replies are validated.
The new register is added to the “Replies” store.
Information is sent to processes 6 and 7.
6) Update messages seen.
With the data coming from process 5, the new register is added to the “messages seen” store.
7) Evaluate replies and increment credits.
With the data coming from process 5, the replies from the consumer are compared to the correct replies for the message.
If the test has been replied to correctly according to certain given criteria, the credits gained are added to the “credits obtained” store (for example, though without limiting ourselves to this: achieving a certain level of correct answers, correctly replying to certain questions in particular, or simply filling in an opinion survey) and the present credits in the consumer's account are updated.
8) Using credits
This permits access by consumers to the services and/or contents of the suppliers, for which it attends to requests for consumption of credits made by the suppliers.
It consults the consumer's credits that are available and the characteristics of the service, and it informs the supplier of whether they are sufficient for paying for the use of its services and/or contents. If so, it calculates the credits remaining in the account of the consumer and updates them, and the transaction is recorded in the “credits spent” store.
9) Statistics (Consumption of User credits)
The supplier requests statistical data on the manner of use and type of consumer using its services and/or contents. For this, we obtain crossed data from the stores “credits spent” and “consumers”.
10) Paying the supplier
The number of credits the consumers have spent on the supplier's services in a certain interval of time is calculated and a pro-forma invoice is issued.
11) Consulting profiles
The supplier statistically consults the profiles of the consumers to see how they are adapted to its services.
12) Invoicing the advertiser
The number of credits obtained by the consumers of the advertiser via the system is calculated and the invoice is issued.
13) Consulting replies
The advertiser statistically consults the replies given to his messages or surveys by the consumers, thereby obtaining statistics equivalent to surveys and market studies.
14) Registration of message
The advertiser introduces the data for a new message.
The introduced data is validated.
It is added to the “messages” store.
15) Managing messages
The advertiser accesses the data and options for his messages.
If they are modified, the “messages” store is updated.
16) Consulting profiles
The advertiser statistically consults the profiles of the consumers in order to adapt his message to his target public.
The system can also be worked by means of mobile telephone or other similar medium.

3. Method for obtaining statistical systems of profiles of suitability for the advertising of products or services, in accordance with claim 1, characterized in that this system can be operated by means of mobile telephone.

4. Method for obtaining statistical systems of profiles of suitability for the advertising of products or services, in accordance with claim 2, characterized in that this system can be operated by means of mobile telephone.
